(19) United States
(12) Patent Application Publication
(10) Pub. No.: US 2014/0265539 A1
(43) Pub. Date: Sep. 18, 2014

(54) BICYCLE WITH IMPROVED CHAIN LINE

(71) Applicant: Specialized Bicycle Components, Inc., Morgan Hill, CA (US)

(72) Inventor: Jeremy Thompson, Aptos, CA (US)

(21) Appl. No.: 14/196,803

(22) Filed: Mar. 4, 2014

Related U.S. Application Data
(60) Provisional application No. 61/790,724, filed on Mar. 15, 2013.

(51) Int. Cl. B60B 27/02

(52) U.S. Cl. CPC B60B 27/023
USPC 301/110.5

(57) ABSTRACT

A bicycle hub configuration that allows the use of a wider rear dropout spacing (e.g., increased from 130 mm to 135 mm) without substantially adversely affecting the alignment of the cassette relative to the chainrings.

### BACKGROUND

The present invention relates generally to the field of bicycles and specifically to a gear changing system with improved chain line.

Many bicycles have transmissions with the ability to change the gear ratio between the input crank and the drive wheel. Such systems commonly include a chain drive system including multiple front chainrings rotatable with the input crank, multiple rear cogs (current styles are commonly called a “cassette”) mounted on the rear wheel hub and rotatable with the rear wheel, and a chain coupling the chainrings with the cogs. The gear ratio is changed using front and rear derailleurs, as is well known in the art.

As bicycle design evolves, bicycle transmission manufacturers have been increasing the number of gear ratios provided by the transmission. This is commonly done by increasing the number of cogs on the rear hub. To make space for the new cogs, the spacing between the cogs has been decreased (e.g., from 3.5 mm to 3.2 mm to 3.0 mm over time) and the overall width (between the frame dropouts) has increased (e.g., from 120 mm to 126 mm to 130 mm to 136 mm over time).

As the hub width increases, the outer edge of the cassette can be moved outward to thereby increase the space for new cogs on the cassette. However, this movement of the outboard edge results in the center of the cassette moving outboard slightly, which can adversely affect the alignment of the cassette with the chainrings (commonly called the “chain line”).

### SUMMARY

The present invention provides a hub configuration that allows the use of a wider rear dropout spacing (e.g., increased from 130 mm to 135 mm) without substantially adversely affecting the alignment of the cassette relative to the chainrings.

Other aspects of the invention will become apparent by consideration of the detailed description and accompanying drawings.

### BRIEF DESCRIPTION OF THE DRAWINGS

FIG. 1 is a side section view of a prior art bicycle rear hub.

FIG. 2 is a side view of a second hub that has a wider hub width and a cassette body moved outward.

FIG. 3 is a side section view of a third hub having a wider hub width and a cassette body not moved substantially outward.

FIG. 4 is a side view of a bicycle to which the present invention can be applied.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIG. 1 illustrates a prior art bicycle rear hub having a hub body 12, right and left spoke flanges 14,16, a cassette body 18, and an axle 20 including left and right end caps 22,24. The end caps are stepped to define an axle length, which in the illustrated embodiment is 131 mm. Various other dimensions of the prior art hub are provided in FIG. 1.

FIG. 2 illustrates a modification of the hub of FIG. 1, wherein the axle spacing has been increased to 136 mm. In this arrangement, the dimensions of the cassette body and the spacing of the right edge of the cassette body from the right end of the axle have been kept substantially the same. As a result of this arrangement, the centerline of the cassette body has been moved to the right about 2.5 mm relative to a centerline of the bicycle. This movement of the cassette body to the right can have an adverse impact on the chainline, and a corresponding adverse impact on the performance (e.g., shifting) of the transmission.

FIG. 3 illustrates a modification of the hub of FIG. 1, wherein the axle spacing has been increased to 135 mm, but the chainline has not been substantially altered. This is accomplished by increasing the length of the right end cap by about 2.5 mm (from 5.63 mm to 8.3 mm) and also by moving the inboard edge of the cassette body closer to the right spoke flange (from 3.4 mm to 2.7 mm). The result is a wider-spaced hub that avoids moving the cassette hub outboard too much, thereby maintaining a desired chainline and corresponding shifting performance.

The concept described above is applicable to a variety of different bicycles, such as the bicycle 30 illustrated in FIG. 4. The bicycle 30 includes a frame 32, front and rear wheels 34, a cassette 36, a rear derailleur 38, chainrings 40, a front derailleur 42, and a chain 44.

Various features of the invention are set forth in the following claims.

1. A bicycle wheel hub comprising:
an axle having end faces defining an axle length between 132 mm and 137 mm;
a hub body mounted for rotation on the axle;
a cassette body mounted for rotation relative to the hub body, the cassette body having an outboard edge that is spaced from the nearest end face by at least 7 mm.

2. A bicycle wheel hub as claimed in claim 1, further comprising a spoke flange adjacent an inboard edge of the cassette body, wherein the inboard edge of the cassette body is spaced from the flange by a distance less than 3 mm.
